(19) United States
(12) Patent Application Publication
(10) Pub. No.: US 2023/0249703 A1
(43) Pub. Date: Aug. 10, 2023

(54) CONTROL METHOD FOR GENERATING VIRTUAL SHIFTING SENSE OF ELECTRIC VEHICLE

(71) Applicants: Hyundai Motor Company, Seoul (KR); Kia Corporation, Seoul (KR)

(72) Inventors: Ji Won OH, Hwaseong-si (KR); Jeong Soo EO, Hwaseong-si (KR)

(21) Appl. No.: 17/977,563

(22) Filed: Oct. 31, 2022

(30) Foreign Application Priority Data
Feb. 7, 2022 (KR) 1020220015202

(51) Int. Cl. B60W 50/10; B60W 10/08

(52) U.S. Cl. CPC B60W 50/10; B60W 10/08; B60W 2710/083; B60W 2710/081; B60W 2510/081; B60W 2540/10

(57) ABSTRACT

A control method for generating a virtual shifting sense of an electric vehicle is proposed. The objective of the control method is to enable a driver to feel differentiated driving sensitivity and various types of enjoyment of driving by generating and implementing a shifting sense in an electric vehicle without a multi-range transmission like a vehicle with a multi-range transmission. In order to achieve the objective, a control method of an electric vehicle that determines a torque range for controlling a motor and virtual shift intervention torque for implementing a virtual shifting sense from virtual variable information, determines driver request torque corresponding to a driving input value by a driver within the determined torque range, and then controls motor torque using the determined driver request torque and virtual shift intervention torque.

### CROSS REFERENCE TO RELATED APPLICATION

The present application claims priority to Korean Patent Application No. 10-2022-0015202, filed Feb. 7, 2022, the entire contents of which is incorporated herein for all purposes by this reference.

### TECHNICAL FIELD

The present disclosure relates to a control method of an electric vehicle and, more particularly, to a control method of an electric vehicle, the method being able to generate and implement a shifting experience in an electric vehicle that does not include a multi-range transmission.

### BACKGROUND

An electric vehicle (EV) is a vehicle that is driven using a motor.

The drive system of a conventional electric vehicle includes a battery that supplies power for driving a motor, an inverter that is connected to the battery, a motor that is a driving device for driving the vehicle and that is connected to the battery through the inverter to be able to charge and discharge, and a reducer that reduces and transmits torque of the motor to driving wheels.

The inverter, which is provided to drive and control the motor, is configured to convert DC supplied from the battery into AC and transmit the AC to a power cable when the motor is driven, and to convert AC generated by the motor into DC and transmit the DC to the battery such that the battery is charged in motor regeneration.

In conventional electric vehicles, a multi-range transmission is not used, unlike existing vehicles equipped with an internal combustion engine, and instead, a reducer that uses a fixed gear ratio is disposed between a motor and the driving wheels.

This is because, unlike an internal combustion engine (ICE) that has a wide energy efficiency distribution according to an operating point and that can provide high torque only in a high-speed period, motors have a relative small difference in efficiency according to an operating point and low-speed torque can be achieved from the characteristics of a single motor.

Further, conventional vehicles equipped with the drive system of an existing internal combustion engine need start devices such as a torque converter or a clutch due to the characteristics of an internal combustion engine that cannot perform low-speed driving, but the drive system of an electric vehicle has a characteristic that a motor can easily implement low-speed driving, so such start devices can be removed.

The drive system of an electric vehicle generates power by driving a motor using the power of a battery rather than generating power by burning fuel like existing vehicle with an internal combustion engine.

Accordingly, unlike the torque of an internal combustion engine that is generated by aerodynamics and thermodynamic reactions, torque in an electric vehicle is characterized by substantially being delicate and smooth and showing a quick response in comparison to the torque of an internal combustion engine.

Due to this mechanical difference, an electric vehicle can provide smooth drivability without disconnection due to shifting unlike a vehicle with an internal combustion engine.

However, non-existence of a transmission in an electric vehicle definitely acts as an advantage in terms of providing smooth drivability without disconnection due to shifting, but non-existence of mechanical parts such as a transmission and non-existence of a shifting sense may bore drivers who want to enjoy driving.

Accordingly, there is a need for a technology that enable a driver to feel the sensitivity and enjoyment of driving, a dynamic sense, a sense of direct connection, etc., which are provided by a vehicle equipped with a multi-range transmission, from an electric vehicle equipped with a reducer without a multi-range transmission.

In particular, a function of implementing virtual drivability may be provided so that a driver can experience desired sensitivity from a same vehicle without replacing a vehicle when the driver wants to feel sensitivity and enjoyment of driving, a dynamic sense, a sense of direct connection, etc., that are provided by an engine, a transmission, a clutch, etc.

### SUMMARY

Accordingly, the present disclosure has been made in an effort to solve the problems described above and an objective of the present disclosure is to provide a control method of an electric vehicle, the control method enabling a driver to feel differentiated driving sensitivity and various types of enjoyment of driving by generating and implementing a shifting sense in an electric vehicle without a multi-range transmission like a vehicle with a multi-range transmission.

The objectives of the present disclosure are not limited to those described above and other objectives not stated herein would be apparently understood by those who have ordinary skills in the art that the present disclosure belongs to (hereafter, ‘those skilled in the art’) from the following description.

In the present disclosure, there is provided a control method for generating a virtual shifting sense of an electric vehicle. The control method includes: collecting, by a control unit, vehicle-driving information while a vehicle is driven; determining, by the control unit, virtual variable information including a virtual gear stage on the basis of the collected vehicle-driving information; determining, by the control unit, a torque range corresponding to a current virtual gear stage of the determined virtual variable information; determining, by the control unit, driver request torque corresponding to a driving input value by a driver of the vehicle-driving information within the determined torque range; determining, by the control unit, virtual shift intervention torque for generating a virtual shifting sense on the basis of the determined virtual variable information when it is determined that the virtual gear stage has been changed; determining and generating, by the control unit, a final torque instruction on the basis of the determined driver request torque and virtual shift intervention torque; and controlling, by the control unit, operation of a motor for driving the vehicle in accordance with the generated final torque instruction.

Therefore, the control method an electric vehicle enables a driver to feel differentiated driving sensitivity and various types of enjoyment of driving by generating and implementing a shifting sense in an electric vehicle without a multi-range transmission like a vehicle with a multi-range transmission by controlling a motor while the electric vehicle is driven.

Further, since a driver can experience a shifting sense that the driver can feel in a vehicle with a multi-range transmission, the commercial value of a vehicle can be improved and the vehicle can be differentiated.

Further, according to existing electric vehicles, a driver cannot control gear stages and can behavior of a vehicle only through a speed and accelerator pedal input, but if a virtual shifting function is implemented in a vehicle that enables high-performance sport driving, it becomes easy to control an entry speed for turning and manage movement of load.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 is a block diagram showing the configuration of a system for generating a virtual shifting sense of an electric vehicle according to the present disclosure;

FIG. 2 is a flowchart showing a control process for generating a virtual shifting sense according to the present disclosure;

FIG. 3 is an exemplary view showing a shifting schedule map for upshift and a shifting schedule map for downshift for determining virtual gear stages in the present disclosure;

FIG. 4 is an exemplary view showing one shifting schedule map that can be used for both upshift and downshift in the present disclosure; and

FIGS. 5 to 7 are views showing examples of a virtual shifting intervention toque profile in the present disclosure.

### DETAILED DESCRIPTION

The present disclosure will be described hereafter in detail with reference to the accompanying drawings. Description of specific structures and functions disclosed in implementations of the present disclosure are only an example for describing the implementations according to the concept of the present disclosure and the implementations according to the concept of the present disclosure may be implemented in various ways. The present disclosure is not limited to the implementations described herein and should be construed as including all changes, equivalents, and replacements that are included in the spirit and the range of the present disclosure.

Like reference numerals indicate the same components throughout the specification. The terms used herein are provided to describe implementations without limiting the present disclosure.

The present disclosure relates to a control method of an electric vehicle, the method being able to generate and implement a virtual multi-stage shifting sense by controlling a motor while a vehicle is driven so that a driver can feel a shifting sense in an electric vehicle without a multi-range transmission like a vehicle with a multi-range transmission.

A ‘motor’ can be a driving motor that drives a vehicle in the following description and a virtual shifting sense can be generated and implemented by controlling torque of a driving motor in a control target vehicle of the present disclosure.

The virtual shifting sense and the virtual shifting effect stated in the present disclosure are not a shifting sense and a shifting effect that are generated by an actual multi-range transmission, but a shifting sense and a shifting effect that can simulate vibration or behavior, which is generated when shifting gears in a vehicle equipped with a multi-range transmission, in a control target vehicle without a transmission.

Such a virtual shifting sense can be a sensitivity that a driver can actually physically feel like a shifting sense while driving by generating vibration or behavior of an actual vehicle by controlling motor torque in a control target vehicle without a transmission. That is, the vibration and behavior of a vehicle for producing a virtual shifting sense the vibration and behavior of an actual vehicle that are generated and provided by a motor in a control target vehicle.

The virtual shifting sense can further include a visual effect for virtual shifting in the present disclosure and the visual effect may be implemented by displaying variable information, which is similar to information that is provided to a driver in an actual vehicle with a transmission, in detail, real-time virtual variable information, which copies variables related to a transmission and drive system, on a display device of the control target vehicle.

The variable information related to a transmission and drive system may include information about the gear stages of a transmission and the rotation speed of an engine (hereafter, referred to as an ‘engine speed’). Further, in the present disclosure, the real-time virtual variable information that is displayed on the display device may include virtual gear stage information that is determined while a virtual shifting mode (automatic shifting mode/manual shifting mode) is performed, that is, the information of a virtual gear stage copying the current gear stage of a transmission that does not actually exist.

Further, the real-time virtual variable information that is displayed on the display device may further include a virtual engine speed (a virtual engine RPM) and the virtual engine speed may be a virtual engine speed that is determined as a value corresponding to the current driving state of a vehicle under the assumption that an engine exists even though it is an electric vehicle without an engine (internal combustion engine).

Further, the virtual shifting sense further includes a virtual aural sound effect, which can be implemented by generating and outputting virtual driving sounds, which copies sounds that are generated during driving including shifting in a vehicle equipped with an actual transmission, through a sound system.

In some implementations, the virtual driving sounds may be virtual engine sounds that copy the engine sounds of a vehicle with an internal combustion engine. In the present disclosure, it is possible to implement a sound effect that is in connection with a virtual engine speed of the virtual variable information and it is possible to generate and output virtual driving sounds corresponding to virtual engine speeds through a sound system in a vehicle.

Further, in the present disclosure, virtual variable information can be determined from real-time vehicle-driving information that is collected from a vehicle during driving, and then virtual shifting intervention torque for implementing a torque range for driving a motor and a virtual shifting sense that corresponds thereto is determined from the determined virtual variable information.

Further, driver request torque can be determined from the determined torque range and driving input information by a driver (an accelerator pedal input value and a brake pedal input value), a final torque instruction is determined using the determined driver request torque and virtual shifting intervention torque, and then motor torque that is applied to driving wheels is controlled in accordance with the final torque instruction, whereby a virtual multi-stage shifting sense corresponding to a driving state is generated and implemented.

In the present disclosure, the torque range may be determined using virtual gear stage information of the virtual variable information, and the driver request torque may be determined as a value corresponding to a driving input value by a driver within the torque range.

In the present disclosure, the virtual gear stages of virtual variables may be determined on the basis of real-time vehicle-driving information in an automatic shifting mode or may be determined by manual shifting by a driver in a manual shifting mode. In this case, the driver can select one of the automatic shifting mode and the manual shifting mode by operating a predetermined input device.

When the automatic shifting mode is selected, virtual gear stages may be determined in real time by a shifting (gear shift) schedule map using actual driving variables, such as an accelerator pedal input value (APS value) (or an acceleration load value), and a virtual vehicle speed. However, in the manual shifting mode, virtual gear stages can be selected and determined in accordance with the state of manual shifting by a driver.

In the present disclosure, virtual gear stages can be determined in real time from vehicle-driving information with the automatic shifting mode selected while a virtual shifting mode is performed (a virtual shifting mode function is on), and if the virtual gear stages determined in this way are changed, the virtual gear stage after the change is a target gear stage in shifting, that is, a virtual target gear stage. Further, when a virtual gear stage determined in this way is changed, virtual shifting control for generating a virtual shifting sense is performed using the virtual gear stage after the change as a target gear stage.

The virtual shifting intervention torque can be torque that can be added to driver request torque to generate, provide, and implement a virtual shifting sense. The virtual shifting intervention torque may be a kind of correction torque that is used to correct driver request torque, and the driver request torque is corrected to generate a virtual shifting sense by controlling a motor in the present disclosure.

The driver request torque may be corrected by adding virtual shifting intervention torque to driver request torque before correction. Further, the driver request torque after correction is a final torque instruction, and the final torque instruction produced by correcting driver request torque is used to control motor torque that is applied to driving wheels.

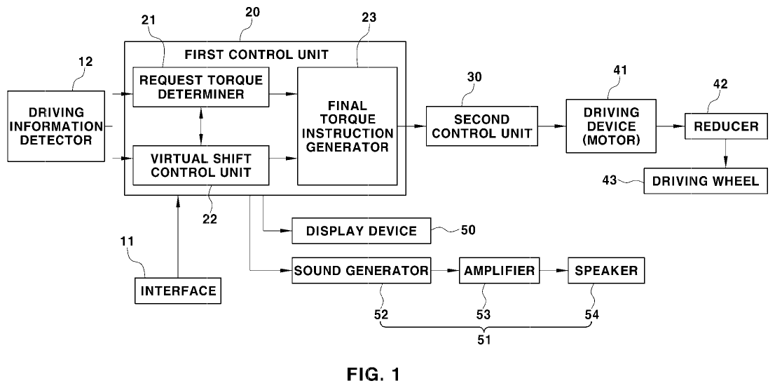

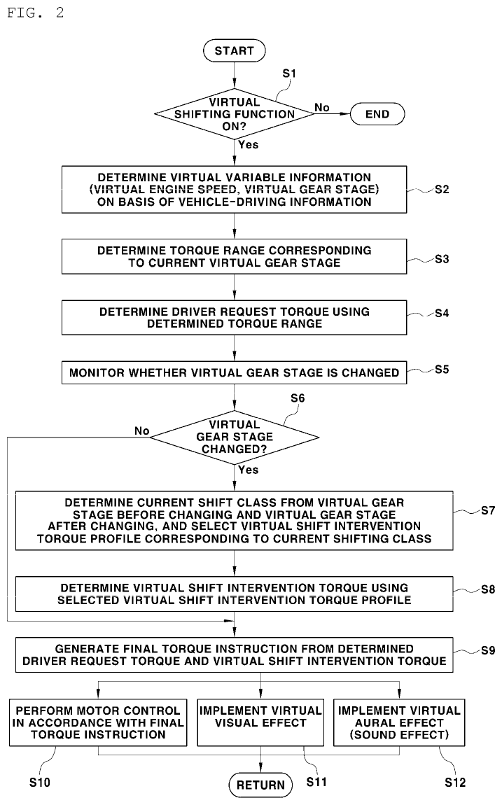

FIG. 1 is a block diagram showing the configuration of a system for generating a virtual shifting sense of an electric vehicle according to the present disclosure and FIG. 2 is a flowchart showing a control process for generating a virtual shifting sense according to the present disclosure.

As for the configuration of a system for generating and implementing a virtual shifting sense according to the present disclosure, as shown in FIG. 1, a system for generating and implementing a virtual shifting sense, which is installed in a vehicle, includes a vehicle-driving information detector 12 that detects vehicle-driving information, a first control unit 20 that generates and outputs a torque instruction on the basis of the vehicle-driving information detected by the vehicle-driving information detector 12, and a second control unit 30 that controls operation of a motor that is a driving device 41 in accordance with the torque instruction output from the first control unit 20.

The vehicle-driving information detector 12 is a component that determined driver request torque in a vehicle and detects vehicle-driving information for performing a virtual shifting function (a virtual shifting sense implementation function), and the vehicle-driving information may include driving input information by a driver and vehicle state information.

In some implementations, the driving information detector 12 may include an accelerator pedal detector that detects accelerator pedal information according to accelerator pedal operation by a driver, and a brake pedal detector that detects brake pedal input information according to brake pedal operation by a driver.

The accelerator pedal detector may be a common accelerator position sensor (APS) that is installed on an accelerator pedal and outputs an electrical signal according to an accelerator pedal operation state by a driver. The brake pedal detector may be a common brake pedal sensor (BPS) that is installed on a brake pedal and outputs an electrical signal according to a brake pedal operation state by a driver.

The driving input information by a driver includes an accelerator pedal input value (APS value) that is a driving input value according to accelerator pedal operation by a driver and is detected by the accelerator pedal detector, and a brake pedal input value (BPS value) that is a driving input value according to brake pedal operation by a driver and is detected by the brake pedal detector.

The driving information detector 12 may further include a paddle shift-shifting lever detector, and a speed detector that detects the speed of an automotive drive system.

The driving input information by a driver may further include paddle shifting input information according to paddle shifting operation by a driver, and shifting lever input information according to shifting lever operation by a driver. The vehicle state information may include the speed of an automotive drive system that is detected by the speed detector.

In the present disclosure, an input device that selects and ends a manual shifting mode through the paddle shifting and the shifting lever may be used without having a separate input device that is operated by a driver to select a manual shifting mode in a vehicle.

The shifting lever input information may be detected by the shifting lever detector and input to a virtual shifting control unit 22 of the first control unit 20, and the paddle shifting input information may be input to the virtual shifting control unit 22 of the first control unit 20 from the paddle shift.

Accordingly, the virtual shifting control unit 22 can determine a virtual target gear stage in accordance with manual shifting input information by a driver (information showing a manual shifting state), that is, shifting lever input information or paddle shifting input information.

In the manual shifting mode, when a driver operates the shifting lever or the paddle shift, virtual shifting can be forcibly performed. Further, in the manual shifting mode, the virtual shifting control unit 22 can determine whether a virtual gear stage has been changed from the shifting lever input information or the paddle shifting input information, and simultaneously, can recognize the changed virtual gear stage (i.e., a virtual target gear stage).

The speed of the automotive drive system may be the rotation sped of a motor that is the driving device 41 (a motor speed), a rotation speed of driving wheels 43 (a driving wheel speed), or the rotation speed of a drive shaft (a drive shaft speed). The speed detector may be a resolver installed at the motor or a wheel speed sensor installed at the driving wheels 43, or may be a sensor that can detect the drive shaft speed.

The first control unit 20 of the components of the system shown in FIG. 1 determines, generates, and outputs a torque instruction on the basis of real-time vehicle-driving information. The first control unit 20 includes a request torque determiner 21 that determines driver request torque from real-time vehicle-driving information, a virtual shifting control unit 22 that determines virtual shifting intervention torque that is correction torque for generating and implementing a virtual shifting sense from the real-time vehicle-driving information, and a final torque instruction generator 23 that corrects the driver request torque input from the request torque determiner 21 into virtual shifting intervention torque input from the virtual shifting control unit 22, and generates and outputs a final motor torque instruction (hereafter, referred to as a ‘final torque instruction’) from the corrected torque.

The request torque determiner 21 can determine driver request torque further using virtual variable information in addition to real-time vehicle-driving information that is collected while an electric vehicle is driven.

The vehicle-driving information is real-time driving input information by a driver and the virtual variable information is real-time virtual gear stage information. In the present disclosure, the virtual variable information is determined on the basis of vehicle-driving information, as will be described below, so the driver request torque may be determined from the vehicle-driving information.

In detail, with the virtual shifting function on (which is step S1 in FIG. 2), the virtual shifting control unit 22 of the first control unit 20 determines virtual variable information on the basis of vehicle-driving information (step S2), and the request torque determiner 21 receives virtual gear stage information of the virtual variable information determined by the virtual shifting control unit 22.

The request torque determiner 21 determines a torque range from the input virtual gear stage information (step S3) and determines driver request torque corresponding to a real-time driving input value by a driver within the determined torque range (step S4).

Further, the request torque determiner 21 transmits the determined driver request torque to the final torque instruction generator 23. The request torque determiner 21 may be a vehicle control unit (VCU) that generates a motor torque instruction on the basis of vehicle-driving information in a common electric vehicle, or may be a part of the vehicle control unit.

The virtual shifting control unit 22 is a new component that determines a virtual shifting intervention torque, which is correction torque only for generating and implementing a virtual shifting sense, and then generates and output an instruction, and may be added as a part in a vehicle control unit or may be provided as a control element that is separate from the vehicle control unit.

In the final torque instruction generator 23, driver request torque (a motor torque instruction before correction) input from the request torque determiner 21 is corrected by virtual shifting intervention torque that is correction torque input from the virtual shifting control unit 22. The final torque instruction generator 23 can add the value of virtual shifting intervention torque that is correction torque to the value of driver request torque and can generate and output a final torque instruction of the sum-up value (which is step S9 in FIG. 2).

The second control unit 30 is a control unit that receives a final torque instruction input from the final torque instruction generator 23 and control operation of the driving device 41. In the present disclosure, the driving device 41 may be a motor that drives a vehicle and the second control unit 30 may be a well-known motor control unit (MCU) that drives a motor through an inverter and controls operation of the motor in a common electric vehicle.

As described above, the second control unit 30 controls operation of a motor that is the driving device 41 in accordance with the final torque instruction of the first control unit 20 (which is S10 in FIG. 2) and the first control unit 20 performs control for implementing a visual effect of virtual shifting (step S11) and implementing an aural effect (sound effect) of virtual shifting (S12).

In the present disclosure, torque and rotation force that are output from a motor that is the driving device 41, as shown in FIG. 1, are reduced by a reducer 42 and then transmitted to the driving wheels 43. When the motor is controlled in accordance with the final torque instruction of the first control unit 20 by the second control unit 30, motor torque, which can generate vibration and behavior of a vehicle that copy a shifting sense by an actual transmission, can be output while a vehicle is driven.

As described above, the first control unit 20 and the second control unit 30 are control units that take part in a control process for producing virtual shifting effects, such as a virtual shifting sense, in a vehicle and a driving control process of a vehicle. The control subjects are classified into the first control unit and the second control unit in the description of the present disclosure, but the virtual shifting effects in a vehicle and the driving control process according to the present disclosure may be performed by one integrated control element.

A plurality of control units and one integrated control element may be collectively referred to as a control unit and the control process of the present disclosure may be performed by the control unit. A ‘control unit’ may be a collective name of the first control unit 20 and the second control unit 30.

However, the system for generating and implementing a virtual shifting sense according to the present disclosure may further include an interface 11 provided for a driver to select and input on or off of the virtual shifting function. The virtual shifting function in the following description means the function of generating and implementing a virtual shifting sense (virtual shifting effect).

The interface 11 may be any device as long as it enables a driver to select on and off of in a vehicle and can output electric signals according to on and off, and for example, may be an operation device such as a button or a switch provided in a vehicle, or the input device or a touch screen of other Audio, Video and Navigation (AVN) systems.

The interface 11 may be connected to the first control unit 20, and in more detail, may be connected to the virtual shifting control unit 22 to be described below of the first control unit 20. Accordingly, when a driver turns on or off the virtual shifting function through the interface 11, an on-signal or off-signal can be input from the interface to the virtual shifting control unit 22 of the first control unit 20. As a result, the virtual shifting control unit 22 of the first control unit 20 can recognize the on-state or off-state of the virtual shifting function by a driver.

In the present disclosure, the virtual shifting function of generating and implementing a virtual shifting sense while a vehicle is driven is performed only when a driver turns on the virtual shifting function through the interface 11 (see step S1 in FIG. 2).

If the interface 11 is an input device installed in a vehicle, a mobile device may be used instead of the input device in a vehicle and a driver may turn on and off the virtual shifting function through the mobile device.

The mobile device should be able to be connected to a device in a vehicle, for example, the first control unit 20 such that communication is possible, and to this end, an I/O communication interface for communication connection between the mobile device and the first control unit 20 is used.

The system for generating and implementing a virtual shifting sense according to the present disclosure may further include, as devices that are installed in a vehicle, a display device 50 that produces a visual effect of virtual shifting (which is step S11 in FIG. 2) and a sound system 51 that produces an aural effect of virtual shifting (which is step S12 in FIG. 2).

The display device 50 and the sound system 51 may be connected to the virtual shifting control unit 22 of the first control unit 20 and may be provided such that operation is controlled in accordance with control signals that are output from the virtual shifting control unit 22 of the first control unit 20.

The display device 50 may be a display device in a cluster installed in front of a driver's seat in a vehicle, and displays and shows virtual variable information, which is determined in correspondence to the current vehicle-driving state while a vehicle is driven, that is, a real-time virtual engine speed and a virtual gear stage to a driver.

When the virtual shifting control unit 22 of the first control unit 20 outputs a control signal for displaying the determined virtual engine sped and virtual gear stage to the display device 50, the display device 50 operates and displays the virtual engine sped and the virtual gear stage in response to the output control signal (step S11).

The sound system 51 may include a sound generator 52, an amplifier 53, and a speaker 54 that are operated in response to a control signal that is output from the virtual shifting control unit 22, that is, a sound control signal.

A sound control signal corresponding to a virtual engine speed is generated and output from the virtual shifting control unit 22 of the first control unit 20. When the output sound control signal is input to the sound generator 52 of the sound system 51, the sound generator 52 operates in response to the input sound control signal and generates and output a virtual sound signal corresponding to the sound control signal.

Accordingly, the virtual sound signal output from the sound generator 52 is amplified by the amplifier 53 of the sound system 51 and then converted and output as a virtual driving sound through the speaker 54 of the sound system 51 (step S12).

Hereafter, the process in which the first control unit determines and generates virtual variable information, virtual shifting intervention torque, a torque range, driver request torque, and a final torque instruction is described in more detail.

It was described above that virtual variable information is used to generate and implement a virtual shifting sense and the virtual shifting sensor includes a virtual engine speed and a virtual gear stage that are determined from real-time vehicle-driving information while a vehicle is driven.

In the present disclosure, the virtual variable information is determined on the basis of real-time vehicle-driving information that is actual driving variable information by the virtual shifting control unit 22 of the first control unit 20. In detail, a real-time virtual engine speed of the virtual variable information that is used to generate and implement a virtual shifting sense may be obtained from an actual vehicle drive system speed that is detected by the speed detector of the driving information detector 12. That is, the virtual engine speed may be a virtual speed that is determined from a real-time drive system speed that is actual driving variable information by the virtual shifting control unit 22 of the first control unit 20.

In some implementations, virtual gear stage information that is another virtual variable information may be further used to acquire a virtual engine speed from the drive system speed that is an actual driving variable in an electric vehicle. As the engine speed is a transmission input speed in a vehicle with an internal combustion engine that is equipped with an engine and a transmission, a virtual engine speed is a virtual transmission input speed in an electric vehicle under the assumption that an engine and a transmission exist.

In this case, the virtual engine speed and the virtual transmission input speed may be determined as values that are in connection with an actual motor speed (the rotation speed of a motor). That is, the virtual engine speed may be calculated as a changeable multiple value of a drive system speed that is detected by the speed detector of the driving information detector 12, in which the drive system speed may be a motor speed.

As described above, a virtual engine speed can be calculated as a changeable multiple value of a motor speed by multiplying the motor speed by a changeable coefficient, in which the value of the changeable coefficient by which the motor speed is multiplied may be a value that is determined in accordance with the current virtual gear stage.

The changeable coefficient may be a virtual gear ratio value determined for each virtual gear stage. That is, the virtual engine speed may be determined from a real-time drive system speed that is determined by the speed detector of the driving information detector 12, and a virtual gear ratio value corresponding to a current virtual gear stage. In detail, the virtual engine speed may be determined as a product of a real-time motor speed, which is detected by the speed detector of the driving information detector 12, by a gear ratio value corresponding to a current virtual gear stage.

As a result, a virtual engine speed that is calculated as described above can be displayed through the display device 50. Further, a post-process correction such as filtering or inclination limitation is applied to a product of a real-time drive system speed and a changeable coefficient and then the corrected virtual engine speed may be displayed through the display device 50.

Meanwhile, a virtual gear stage of the virtual variable information may be determined from real-time vehicle-driving information, that is, actual driving variables such as a virtual vehicle speed showing the current vehicle-driving state and an accelerator pedal input value on the basis of a preset shifting schedule map by the virtual shifting control unit 22 of the first control unit 20.

The virtual vehicle speed may be calculated as a value that is proportioned to a motor speed by multiplying a real-time motor speed that is an actual driving variable, that is, a real-time motor speed, which is detected by the speed detector of the driving information detector 12, by a preset virtual final gear ratio.

However, when it is a manual shifting mode in which there is manual shifting input by a driver, that is, a manual shifting mode in which a shifting lever or a paddle shifting is operated by a driver, a virtual gear stage is determined in accordance with the manual shifting state by the virtual shifting control unit 22.

When it is an automatic shifting mode (it is not the manual shifting mode or there is no manual shifting by a driver), the virtual shifting control unit 22 of the first control unit 20 determines a virtual gear stage from a current virtual vehicle speed and an actual driving variable, but in the manual shifting mode, a virtual gear stage is determined from shifting lever input information or paddle shifting input information by a driver.

The method of determining a real-time virtual gear stage and determining that a virtual gear stage has been changed in the automatic shifting mode is described in more detail. The virtual shifting control unit 22 of the first control unit 20 can use a shifting schedule map having actual driving variables, such as a virtual vehicle speed (km/h) and an accelerator pedal input value (APS value) (%), as input.

The shifting schedule map may be a map in which virtual gear stages corresponding to combinations of input variables, which are actual driving variables such as a virtual vehicle speed and an accelerator pedal input value, are set in advance.

Thresholds for changing gear stages in upshift and downshift using a virtual vehicle speed and actual driving variable information as input may be set in the shifting schedule map.

A shifting schedule map for upshift in which thresholds for changing gear stages in upshift are set and a shifting schedule map for downshift in which thresholds for changing gear stages in downshift are set may be used. That is, different shifting schedule maps may be used for upshift and downshift, respectively.

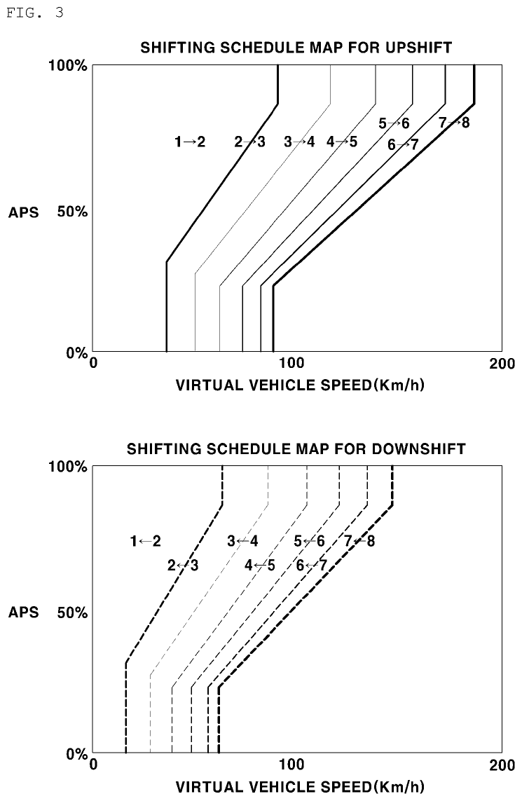

FIG. 3 is a view exemplifying shifting schedule maps for determining virtual gear stages in the present disclosure, in which a shifting schedule map for upshift and a shifting schedule map for downshift that may be separately provided in the virtual shifting control unit 22 are exemplified.

In the present disclosure, the definitions of the upshift and the downshift are the same as those in an actual transmission, that is, the upshift is defined as when a gear is changed into a higher gear and the downshift is defined as when a gear is changed into a lower gear.

The horizontal axis is a vehicle speed (km/h) and the vertical axis is an accelerator pedal input value (APS value) in the shifting schedule maps, in which the vehicle speed of the horizontal axis is a virtual vehicle speed. As described above, a virtual vehicle speed and an accelerator pedal input value showing intention of a driver may be input in the shifting schedule maps, and virtual gear stages corresponding to virtual vehicle speeds and accelerator pedal input values are determined from the shifting schedule maps.

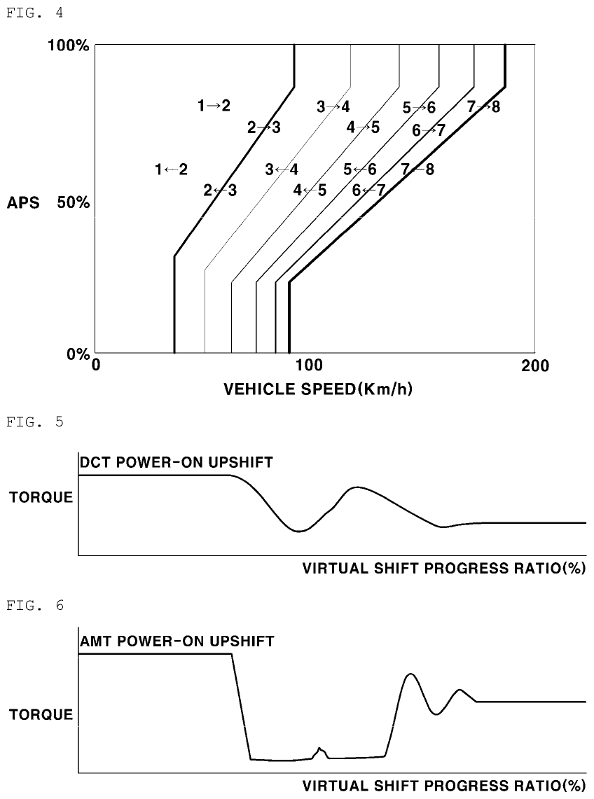

Alternatively, the virtual shifting control unit 22 may have and use one shifting schedule map without discrimination shifting schedule maps for upshift and downshift. FIG. 4 is an exemplary view showing one shifting schedule map that can be used for both upshift and downshift in the present disclosure. Referring to the example of FIG. 4, it can be seen that thresholds for changing gear stages are set to be same in upshift and downshift.

When one shifting schedule map shown in FIG. 4 is used, in order to implement a hysteresis between upshift and downshift, it is possible to additionally correct a virtual vehicle speed determined as described above only in downshift and then use the corrected virtual vehicle speed for a virtual vehicle speed for downshift.

In this case, it may be possible to determine the virtual vehicle speed for downshift as a value obtained by multiplying a virtual vehicle sped before correction by a scale factor larger than 1 and then adding a preset positive offset value to the product of the virtual vehicle speed before correction by the scale factor. Accordingly, in downshift, it is possible to determine a virtual gear stage by applying the virtual vehicle speed before correction, that is, the virtual vehicle speed for downshift to the shifting schedule map of FIG. 4.

In upshift, a virtual vehicle speed before correction is used as is, and a real-time virtual vehicle speed that has not been corrected is applied to the virtual vehicle speed of FIG. 4, whereby a virtual gear stage is determined. When determining a virtual gear stage using the shifting schedule map, it is possible to replace the virtual vehicle speed (km/hr) with a drive system speed (rpm) that is detected by the speed detector of the driving information detector 12. Alternatively, when determining a virtual gear stage, it is possible to replace the virtual vehicle speed (km/hr) with a virtual speed that is calculated from the drive system speed, that is, a virtual engine speed.

As the actual driving variable information, a brake pedal input value (BPS value), driver request torque that is determined by the request torque determiner 21, or the like may be used instead of an accelerator pedal input value (APS value) that is driving input information by a driver.

The request torque determiner 21 of the first control unit 20 determines driver request torque corresponding to a real-time driving input value by a driver. In order to determine driver request torque in this way, the request torque determiner 21 determines first a torque range corresponding to a current virtual gear stage (which is step S3 in FIG. 2).

That is, when the virtual shifting control unit 22 of the first control unit 20 determines and output a current virtual gear stage in real time, the request torque determiner 21 receives the output virtual gear stage information. Accordingly, the request torque determiner 21 determines a torque range corresponding to the current virtual gear stage on the basis of the input virtual gear stage information.

Further, the request torque determiner 21 determines driver request torque corresponding to a driving input value by a driver, which is detected by the driving information detector 12, within the determined torque range on the basis of the driving input value by a driver. Accordingly, driver request torque can be transmitted and input to the final torque instruction generator 23 from the request torque determiner 21.

A torque range may be set in advance for each virtual gear stage in the request torque determiner 21 of the first control unit 20 so that torque ranges can be determined as described above, and a torque range corresponding to a current virtual gear stage can be determined by the request torque determiner 21 in accordance with the setting information. Larger torque ranges may be set for lower virtual gear stages of a plurality of virtual gear stages in the setting information

The following Table 1 shows, as an example of the setting information, torque ranges set for virtual gear stages, respectively, that is, shows an example of driver request torque calculated when an accelerator pedal input value (APS value), which is a driving input value by a driver, is 40% and 100% at each virtual gear stage.

In Table 1, ‘A’ is a driver request torque value calculated when the torque range for each virtual gear stage is composed of a positive (+) torque region and a negative (−) torque region and the accelerator pedal input value (APS value) is 40%, and ‘B’ is a driver request torque value calculated when the torque range for each virtual gear stage is determined as only a positive (+) torque region including 0 and the accelerator pedal input value (APS value) is 40%. That is, ‘B’ is a driver request torque value when a torque range is 0˜400 Nm, 0˜250 Nm, and 0˜150 Nm in accordance with virtual gear stages.

TABLE 1

| | | | Driver request | | |
|---|---|---|---|---|---|
| | | | torque for APS | | Driver request |
| Virtual | Designated | Torque | value of 40% | | torque for APS |
| gear | virtual | range | [N · m] | | value of 100% |
| stage | gear ratio | [N · m] | A | B | [N · m] |
| 1 | 4 | −100~+400 | 100 | 160 | 400 |
| 2 | 2.5 | −62.5~+250 | 62.5 | 100 | 250 |
| 3 | 1.5 | −37.5~+150 | 37.5 | 60 | 150 |

As shown in Table 1, a virtual gear ratio corresponding to the gear ratio of an actual transmission is designated and determined for each virtual gear stage, and lower virtual gear ratios may be set for higher virtual gear stages.

The torque range of each virtual gear stage may be determined only as a positive (+) torque region, and in this case, the torque region may be a positive (+) torque region of which the lower limit value is 0. As another example, the torque range of each virtual gear stage may be determined as a range including both a negative (−) torque region and a positive (+) torque region by further including a negative (−) torque region. That is, each torque range may be composed of a negative (−) torque region and a positive (+) torque region. In this case, the upper limit value is a positive (+) torque value and the lower limit value is a negative (−) torque value.

Further, in some implementations, smaller torque ranges may be set for higher virtual gear stages.

In general, the higher the gear stage, the lower the gear ratio. That is, the higher the gear stage, the lower the engine speed at the same vehicle speed, and the higher the gear stage, the smaller the wheel transmission torque under the assumption that constant engine torque is generated.

Smaller torque ranges can be set for higher virtual gear stages in consideration of this effect, and accordingly, it is possible to copy the effect that the higher the gear stage, the smaller the maximum wheel transmission torque in a vehicle with an actual transmission.

In some implementations, the width of the torque range of each virtual gear stage, that is, the difference (gap) between the lower limit value and the upper limit valve may be set to be proportioned to the virtual gear ratio designated to each virtual gear stage or to have a similar pattern. The width of a torque range may be set to depend on a virtual gear ratio value.

In this case, the upper limit value and the lower limit value of the torque range of each virtual gear stage may be set as a value that depends on the virtual gear ratio value of the corresponding virtual gear stage. For example, the upper limit value and the lower limit value of each torque range may be set as values that are proportioned to a virtual gear ratio value. Further, an equation may be used such that the upper limit value and the lower limit value of the torque range can be determined as a function of a virtual gear ratio.

In the example of Table 1, the upper limit value (Nm) of the torque range of each virtual gear stage is determined as the product of the virtual gear ratio value of a corresponding virtual gear stage by +100, and the lower limit value (Nm) is determined as the product of the virtual gear ratio value of a corresponding virtual gear stage by −25.

Further, Table 1 shows an example in which the torque range of each virtual gear stage has a positive (+) torque value as an upper limit value and a negative (−) torque value as a lower limit value, in which each torque range is composed of a positive (+) torque region and a negative (−) torque region. In Table 1, for a first virtual gear stage, the lower limit value of the torque range is determined as −100 Nm and the upper limit value is determined as +400 Nm.

Similarly, the lower limit value of the torque range is determined as −62.5 Nm and the upper limit value is determined as +250 Nm for a second virtual gear stage, and the lower limit value of the torque range is determined as −37.5 Nm and the upper limit value is determined as +150 Nm for the third virtual gear stage.

The numerical value of each torque range, that is, the numerical values of the upper limit and the lower limit of each torque range shown in Table 1 are only examples and the present disclosure is not limited to the numerical values, and the numerical values of the upper limit and the lower limit shown in Table 1 can be corrected and changed in various ways. It may be possible to make a driver adjust the numerical values in person using an input device.

In each of the torque ranges exemplified in Table 1, the positive (+) torque region is a torque region when a vehicle is accelerated and the negative (−) torque region is a torque region when a vehicle is decelerated. The negative (−) torque region may be considered as a coasting regenerative torque region.

When driver request torque is determined as the positive (+) torque region of the torque range corresponding to a current virtual gear stage with an accelerator pedal operated by a driver, the driver request torque is torque for accelerating a vehicle.

However, when driver request torque is determined as the negative (−) torque region of the torque range corresponding to a current virtual gear stage with an accelerator pedal operated by a driver, the driver request torque is torque that decelerates a vehicle even though the accelerator pedal has been operated, so this torque may be considered as torque that obtains the effect of engine brake as a coasting regenerative torque. As described above, driver request torque that decelerates a vehicle may be determined in the negative (−) torque region of the torque range corresponding to a current virtual gear stage even with an accelerator pedal slightly operated by a driver.

As described above, driver request torque values calculated when the torque ranges of virtual gear stages are each composed of a positive (+) torque region and negative (−) torque region and the accelerator pedal input value (APS value) is 40% are the values shown in ‘A’ in Table 1.

Further, as described above, the torque range of virtual gear stages, unlike the example of Table 1, may be determined as only a positive (+) torque region including 0 in the present disclosure, and driver request torque values calculated when the accelerator pedal input value (APS value) is 40% in this case are the values shown in ‘B’ in Table 1.

The values of ‘A’ in the example shown in Table 1 are described in more detail. In the case in which the accelerator pedal input value (APS value) that is a driver request torque value is 40%, when the current virtual gear stage is the first gear stage, 100 Nm corresponding to 40% of the torque range having a lower limit value of −100 Nm and an upper limit value of +400 Nm can be determined as driver request torque.

When the current virtual gear stage is the second gear stage, 62.5 Nm corresponding to 40% of the torque range having a lower limit value of −62.5 Nm and an upper limit value of +250 Nm can be determined as driver request torque.

Similarly, when the current virtual gear stage is the third gear stage, 37.5 Nm corresponding to 40% of the torque range having a lower limit value of −37.5 Nm and an upper limit value of +150 Nm can be determined as driver request torque. As described above, a torque value corresponding to 40% of the torque range corresponding to a current virtual gear stage can be described as driver request torque.

As for the example when the accelerator pedal input value (APS value) is 100%, when the current virtual gear stage is the first gear stage, 400 Nm corresponding to 100% of the torque range having a lower limit value of −100 Nm and an upper limit value of +400 Nm can be determined as driver request torque.

When the current virtual gear stage is the second gear stage, 250 Nm corresponding to 100% of the torque range having a lower limit value of −62.5 Nm and an upper limit value of +250 Nm can be determined as driver request torque.

Similarly, when the current virtual gear stage is the third gear stage, 150 Nm corresponding to 100% of the torque range having a lower limit value of −37.5 Nm and an upper limit value of +150 Nm can be determined as driver request torque. As described above, a torque value corresponding to 100% of the torque range corresponding to a current virtual gear stage can be described as driver request torque.

Although Table 1 shows only examples when the accelerator pedal input value is 40% and 100%, the driver request torque can be changed in accordance with the accelerator pedal input value (APS value) in the torque range of each virtual gear stage.

For example, when an accelerator pedal input value of driving input values by a driver is input to the first control unit 20, the first control unit 20 may determine driver request torque as a value that is proportioned to the accelerator pedal input value between the lower limit value and the upper limit value of the torque range corresponding to a current virtual gear stage.

The values of ‘B’ in the example of Table 1 are described. The value of ‘B’ is a driver request torque value when the lower limit value of each torque range is 0. In the case in which the accelerator pedal input value (APS value) that is a driving input value by a driver is 40%, when the current virtual gear stage is the first gear stage, 160 Nm corresponding to 40% of the torque range having a lower limit value of 0 Nm and an upper limit value of +400 Nm can be determined as driver request torque.

When the current virtual gear stage is the second gear stage, 100 Nm corresponding to 40% of the torque range having a lower limit value of 0 Nm and an upper limit value of +250 Nm can be determined as driver request torque.

Similarly, when the current virtual gear stage is the third gear stage, 60 Nm corresponding to 40% of the torque range having a lower limit value of 0 Nm and an upper limit value of +150 Nm can be determined as driver request torque. As described above, a torque value corresponding to 40% of the torque range corresponding to a current virtual gear stage can be described as driver request torque.

As for the example when the accelerator pedal input value (APS value) is 100%, when the current virtual gear stage is the first gear stage, 400 Nm corresponding to 100% of the torque range having a lower limit value of 0 Nm and an upper limit value of +400 Nm can be determined as driver request torque.

When the current virtual gear stage is the second gear stage, 250 Nm corresponding to 100% of the torque range having a lower limit value of 0 Nm and an upper limit value of +250 Nm can be determined as driver request torque.

Similarly, when the current virtual gear stage is the third gear stage, 150 Nm corresponding to 100% of the torque range having a lower limit value of 0 Nm and an upper limit value of +150 Nm can be determined as driver request torque. As described above, a torque value corresponding to 100% of the torque range corresponding to a current virtual gear stage can be described as driver request torque.

The values of ‘B’ in Table 1 are driver request torque values when the torque ranges of the virtual gear stages are determined as only positive (+) torque regions, and in this case, the lower limit values may be 0 Nm, as described above, but may be positive torque values larger than 0.

The following Equation 1 is an equation from which a driver request torque value can be obtained as a value that is proportioned to an accelerator pedal input value (APS value) between the lower limit value and the upper limit value of the torque range corresponding to a current virtual gear stage.

driver request torque=(Tq₁−Tq₂)×accelerator pedal input value[%]/100+Tq₂ [Equation 1]

In this equation, Tq₁ is the upper limit value of the torque range corresponding to a current virtual gear stage and Tq₂ is the lower limit value of the torque range corresponding to a current virtual gear stage. Further, [%] is the unit of the accelerator pedal input value (APS value).

As described above, driver request torque can be determined as a value corresponding to an accelerator pedal input value (APS value), which is a driving input value by a driver, in the torque range corresponding to a current virtual gear stage from the setting information of Table 1 with an accelerator pedal depressed by the driver.

Equation 1 is an equation that determines driver request torque as a value that is linearly proportioned to an accelerator pedal input value in the torque range corresponding to a current virtual gear stage, but driver request torque may be determined as a value that is not linearly changed and is continuously and non-linearly changed by a set function.

As another example, driver request torque may be determined by a map, and in this case, every driver request torque in the map when the accelerator pedal input value is 100% is determined as a value within the torque ranges corresponding to current virtual gear stages.

Although it was exemplified above that whether coasting regenerative torque is obtained when a vehicle is decelerated regardless of a brake pedal, driver request torque that is the value of ‘A’ in Table 1 may be calculated as a negative (−) torque value when a driver slightly operates an accelerator pedal. Driver request torque that is obtained as a negative (−) torque value in this way is torque that enables deceleration of a vehicle and coasting regeneration by applying negative (−) torque to a motor even though an accelerator pedal is operated.

For example, when the current virtual gear stage is the first gear stage and the accelerator pedal input value (APS value) is 10%, the ‘A’ value can be determined as ‘[400−(−100)]×0.1+(−100)=−50 Nm’ by Equation 1, in which −50 Nm that is driver request torque is coasting regenerative torque that decelerates a vehicle.

Further, if a driver has depressed a brake pedal, the driver request torque is a regenerative braking torque value except for friction braking torque from the total brake torque corresponding to a brake pedal input value (BPS value) by a driver, and a final torque instruction for a motor is determined by adding a virtual shifting intervention torque value to the regenerative braking torque value. In this case, the regenerative braking torque value is a value that is obtained from a vehicle in which regenerative braking is performed by a well-known method.

In the present disclosure, the virtual shifting control unit 22 of the first control unit 20 determines and outputs virtual shifting intervention torque only when it is determined that a virtual gear stage has been changed. If there is no change of a virtual gear stage, the virtual shifting control unit 22 may not determine and output virtual shifting intervention torque. In this case, in the final torque instruction generator 23, the virtual shifting intervention torque becomes 0 and the driver request torque becomes the final torque instruction value without torque correction.

Further, the final torque instruction that is generated and output from the final torque instruction generator 23 is a motor torque instruction, which is input to the second control unit 30. Accordingly, the second control unit 30 controls operation of a motor through an inverter on the basis of the final torque instruction input received from the final torque instruction generator 23 of the first control unit 20.

Accordingly, a shifting sense copying the state of a vehicle with a transmission during shifting can be generated and provided when virtual shifting is performed in an electric vehicle, and jerk of a vehicle that is generated by a shifting effect can be implemented similar to shifting of an actual transmission.

Further, under a condition that regenerative braking and friction braking are both performed when braking is performed by a driver depressing a brake pedal, similar to a common electric vehicle, regenerative braking torque and friction braking torque should be distributed in the present disclosure, and in this case, the sum of the regenerative braking torque and friction braking torque should satisfy driver request braking torque.

Accordingly, under the condition that regenerative braking and friction braking are distributed, when driver request braking torque is determined by the request torque determiner 21 of the first control unit 20, the driver request torque is distributed into regenerative braking torque and friction braking torque, and the regenerative braking torque is transmitted to the final torque instruction generator 23 as driver request torque for determining a final torque instruction.

Even in this case, driver request torque and virtual shifting intervention torque are summed up in the final torque instruction generator 23, whereby a final torque instruction (regenerative braking torque instruction) of the sum-up value can be output to the second control unit 30.

Next, a process of determining virtual shifting intervention torque is described. As described above, when the virtual shifting function is turned on through the interface 11 (see step S1 in FIG. 2), a virtual shifting mode is started and the virtual shifting control unit 22 of the first control unit 20 determines in real time a virtual gear stage on the basis of vehicle driving information that is collected while a vehicle is driven (step S2).

That is, a virtual vehicle speed may be determined on the basis of real-time vehicle driving information, and a virtual gear stage may be determined from actual driving variables, such as the determined virtual vehicle speed and an accelerator pedal input value, by a shifting schedule map. Alternatively, when a driver manually shifts, a virtual gear stage may be determined in accordance with the manual shifting state.

While the virtual shifting control unit 22 monitors whether the determined real-time virtual gear stage is changed (which is step S5 in FIG. 2), it is determined that there is a shifting request when a virtual gear stage is changed (see step S6 in FIG. 2), and virtual shifting control for generating a virtual shifting sense is performed using the virtual gear stage after changing as a target gear stage.

When a virtual gear stage is changed, the virtual shifting control unit 22 determines virtual shifting intervention torque to generate a virtual shifting sense, in which the virtual shifting intervention torque may be determined as a function of a virtual engine speed and a virtual gear stage that are virtual variable information.

To this end, virtual shifting intervention torque profile information having a virtual shifting progress ratio (%) as a variable may be input and stored in advance in the virtual shifting control unit 22 to be used. The virtual shifting intervention torque profile information may be obtained by setting a virtual shifting intervention torque value, which changes in accordance with the virtual shifting progress ratio (%), as a continuous value.

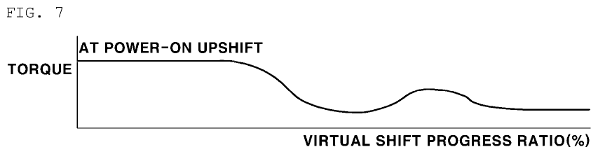

FIGS. 5 to 7 are views showing examples of a virtual shifting intervention toque profile in the present disclosure. The virtual shifting control unit 22 can determine a virtual shifting intervention torque value to a current virtual shifting progress ratio (%) from the virtual shifting intervention torque profile information of the example shown in the figures.

Values from 0% to 100% may be used as the virtual shifting progress ratio (%). When the virtual shifting progress ratio is 0%, it may mean the state before virtual shifting is started, and when virtual shifting progress ratio is 100%, it may mean the state in which virtual shifting is finished.

Further, the phase of virtual shifting intervention torque may be made change in accordance with shifting classes when the virtual shifting intervention torque is calculated, and to this end, different items of virtual shifting intervention torque profile information may be provided and used for shifting classes, respectively.

In some implementations, the shifting classes may include power-on upshift, power-off upshift, power-on downshift, power-off downshift, and near-stop downshift.

The virtual shifting control unit 22 determines a current shifting class to calculate virtual shifting intervention torque (see step S7 in FIG. 2). As a method of determining a current shifting class, when a virtual target gear stage that is a virtual gear stage after changing is higher than a virtual current gear stage that is the virtual gear stage before changing (i.e., the number of a target virtual gear state>the number of a virtual current gear stage), it is upshift; and when a virtual target gear stage is lower than a virtual current gear stage (i.e., the number of a target virtual gear state<the number of a virtual current gear stage), it is downshift.

When driver request torque determined and input by the request torque determiner 21 is larger than a preset reference torque value, it is power-on, and when smaller, it is power-off.

As a result, when a current shifting class is determined on the basis of a virtual current gear stage (virtual gear stage before changing), a virtual target gear stage (virtual gear stage after changing), etc., the virtual shifting control unit 22 selects a virtual shifting intervention torque profile corresponding to the current shifting class from the virtual shifting intervention torque profiles of the shifting classes (which is step S7 in FIG. 2).

The virtual shifting control unit 22 determines in real time virtual shifting intervention torque for generating a virtual shifting sense in accordance with the selected virtual shifting intervention torque profile (which is step S8 in FIG. 2), and a virtual shifting intervention torque value corresponding to a current virtual shifting progress ratio (%) is determined from the selected virtual shifting intervention torque profile.

As described above, a virtual shifting intervention torque profile is information that may be set in advance for each shifting class in the virtual shifting control unit 22, and virtual shifting intervention torque profiles further considering the kind of a transmission other than the shifting classes may be set. The kind of a transmission may include an automatic transmission (AT), a dual clutch transmission (DCT), an automated manual transmission (AMT), etc.

The magnitude of virtual shifting intervention torque may be adjusted by using one or both of a virtual current gear state and a virtual target gear stage, and at least one or more of a virtual engine speed, an accelerator pedal input value (APS value), and motor toque as setting variables of a torque magnitude. The motor torque may be driver request torque that is determined by the request torque determiner 21.

In general, it is natural to increase the magnitude of virtual shifting intervention torque as the magnitude of motor toque (i.e., driver request torque) increases, to decrease virtual shifting intervention torque due to an inter-stage ratio, which decreases as the numbers of gear stages increase, and to increase the magnitude of virtual shifting intervention torque because the higher the virtual engine speed, the larger the speed drop and rise in shifting.

Hereafter, a virtual shifting progress ratio (%) that is obtained by the virtual shifting control unit of the first control unit during shifting is described.

The virtual shifting progress ratio (%) defines the ratio of the degree of progress of shifting from the point in time at which virtual shifting is started in the entire process in percent. The virtual shifting progress ratio at the point in time at which virtual shifting is started is 0%, and when the virtual shifting progress ratio is 100%, it means that shifting is finished. The point in time at which the virtual shifting progress ratio is 0% is the point in time at which virtual shifting is started, and the point in time at which the virtual shifting progress ratio is 100% is the point in time at which virtual shifting is finished.

When a virtual gear stage that is obtained in real time while a vehicle is driven is changed, the virtual shifting control unit 22 of the first control unit 20 determines that there is a shifting request, and can start shifting control at the point in time at which the virtual gear stage was changed. That is, shifting is started at the point in time at which a virtual gear stage is changed.

In the virtual shifting control unit 22, the point in time at which a virtual gear stage was changed is determined as a point in time at which shifting was started, in which the point in time at which a virtual gear stage was changed is the point in time at which the virtual shifting progress ratio is 0%. That is, the virtual shifting progress ratio is 0% at the point in time at which a virtual gear stage was changed.

Alternatively, a delay time may be set in advance in the virtual shifting control unit 22. The virtual shifting control unit 22 may start shifting control at the point in time at which the set delay time elapsed from the point in time at which a virtual gear stage was changed. That is, shifting is started at the point in time at which the delay time elapsed.

In the virtual shifting control unit 22, the point in time at which the delay time elapsed is determined as a point in time at which shifting was started, in which the point in time at which a virtual gear stage was changed is the point in time at which the virtual shifting progress ratio is 0%. That is, the virtual shifting progress ratio is 0% at the point in time at which delay time elapsed from the point in time at which a virtual gear stage was changed.

The virtual gear stage before changing may be used as a current virtual gear stage (virtual current gear stage) in the control process until the virtual shifting progress ratio becomes 100%, that is, until the point in time at which shifting is finished. The virtual gear stage after changing (which was a virtual target gear stage) may be replaced with a new current virtual gear stage after the virtual shifting progress ratio of 100%, that is, from the point in time at which shifting is finished.

In some implementations, the virtual shifting progress ratio (%) may express where a current virtual engine speed during shifting is between a virtual current gear stage-based target input speed and a virtual target gear stage-based target input speed.

In the virtual current gear stage-based target input speed and the virtual target gear stage-based target input speed, the virtual current gear stage means a virtual gear stage before changing and the virtual target gear stage means a virtual gear stage after changing.

In the virtual current gear stage-based target input speed and the virtual target gear stage-based target input speed, the input speed means a transmission input speed. Further, as the engine speed is the transmission input speed in a vehicle with an engine and a transmission, a virtual engine speed may be a virtual transmission input speed, so the virtual current gear stage-based target input speed and the virtual target gear stage-based target input speed may be target virtual engine speeds in a virtual current gear stage-based and a virtual target gear stage-based.

The virtual current gear stage-based target input speed is a virtual engine speed that is obtained at the point in time at which shifting was started, and may be calculated from an actual drive system speed at the point in time at which shifting was started and a virtual gear ratio value of a virtual gear stage before changing (virtual current gear stage).

The virtual target gear stage-based target input speed, which is calculated using the virtual gear ratio value of a virtual gear stage after changing, may be calculated from an actual drive system speed at the point in time at which shifting was started and a virtual gear ratio value of a virtual gear stage after changing (virtual target gear stage).

As described above, the virtual current gear stage-based target input speed and the virtual target gear stage-based target input speed use the same drive system speed (which is a detected speed at the point in time at which shifting was started), but are values calculated using the virtual gear ratio value of a virtual gear stage before changing and the virtual gear ratio value of a virtual gear stage after changing, respectively.

The virtual gear ratio value is a gear ratio value designated for each virtual gear stage, as described above, and the virtual gear ratio value of a virtual gear stage before changing and the virtual gear ratio value of a virtual gear stage after changing are different from each other. Accordingly, the virtual current gear stage-based target input speed and the virtual target gear stage-based target input speed have a speed difference due to the gear ratio value difference between two virtual gear stages.

In the present disclosure, a virtual engine speed is calculated using an actual drive system speed detected by the speed detector of the driving information detector 12, and the virtual gear ratio value of a virtual gear stage. If a motor speed is used as the drive system speed, a real-time virtual engine speed may be calculated as the product of a real-time motor speed, which is detected by the speed detector, and a virtual gear ratio value.

In this case, the virtual current gear stage-based target input speed and the virtual target gear stage-based target input speed are calculated as the products of the motor speed detected by the speed detector of the driving information detector 12 at the point in time at which shifting was started, by the gear ratio value of a virtual gear stage before changing (virtual current gear stage) and the virtual gear ratio value of a virtual gear stage after changing (virtual target gear stage).

Further, in some implementations, the virtual shift progress ratio (%) during shifting may be determined as the percentage (%) of the speed difference between a current virtual engine speed (OmegaVir) during shifting and a virtual current gear stage-based target input speed (OmegaCur) to the speed difference between a virtual target gear stage-based target input speed and the virtual current gear stage-based target input speed (OmegaCur) determined at the point in time at which shifting was started.

This is expressed as the following equation.

virtual shift progress ratio (%)|(OmegaVir−OmegaCur)|/|(OmegaTar−OmegaCur)|×100 [Equation 3]

where ‘∥’ is the symbol of an absolute value. The current virtual engine speed (OmegaVir) during shifting, which is calculated using virtual gear stage information before changing, may be calculated using an actual drive system speed, which is detected in real time by the speed detector of the driving information detector 12, and the virtual gear ratio value of a virtual gear stage before changing.

For example, the current virtual engine speed (OmegaVir) during shifting may be calculated as the product of a real-time motor speed, which is detected by the speed detector of the driving information detector 12, and the virtual gear ratio value of a virtual gear stage before changing.

Alternatively, the current virtual engine speed (OmegaVir) during shifting may be determined as a value obtained by applying a preset rate limit to the product of a real-time motor speed and the virtual gear ratio value of a virtual gear stage before changing.

That is, the product of an actual drive system speed and a virtual gear ratio value may be used as the current virtual engine speed (OmegaVir) during shifting, but the current virtual engine speed may be determined as a value that changes while maintaining the preset rate limit from the virtual current gear stage-based target input speed (which is a current gear stage-based virtual engine speed) to the virtual target gear stage-based target input speed (which is a target gear state-based virtual engine speed).

Further, as shifting somewhat progresses, the virtual target gear stage-based target input speed (OmegaTar) may be replaced with the current virtual engine speed (OmegaVir).

As a result, assuming that a real-time virtual shift progress ratio (%) during shifting is obtained as in Equation 3, virtual shift intervention torque corresponding to the current virtual shift progress ratio (%) obtained as described above can be determined in real time from the virtual shift intervention torque profile information in the virtual shift control unit 22 during shifting from the point in time at which shifting was started.

In some implementations, when a virtual gear stage is changed, the virtual shift control unit 22 may count time during shifting from the point in time at which shifting was started, and may determine the current virtual shift progress ratio (%) in real time using the counted time.

In this case, the virtual shift progress ratio (%) may be determined as the percentage of the counted time to a preset total shifting time. Accordingly, the virtual shift control unit 22 can determine the virtual shift progress ratio (%) that changes from 0% to 100% as time elapses during the set total shifting time from the point in time at which shifting was started.

Meanwhile, it was described above that a virtual gear ratio is designated and determined for each virtual gear ratio and a virtual vehicle speed can be calculated using a final gear ratio.

In some implementations, the virtual gear ratio or the final gear ratio in the first control unit 20 may be input and set or changed by a user through the input device of the interface 11. That is, a user can check a currently set virtual gear ratio for each virtual gear stage in a setting menu, and if necessary, can change the set virtual gear ratios of the virtual gear stages into desired values.

When virtual gear ratio values are changed by a driver, the torque ranges of the virtual gear stages shown in Table 1 can also be changed in accordance with the changed virtual gear ratio values. For example, the upper limit values and the lower limit values of torque ranges may be newly determined as values that are proportioned to the virtual gear ratio values changed by a driver in the virtual shift control unit 22 of the first control unit 20.

In more detail, when the virtual gear ratio value of a certain virtual gear stage is changed by a user, an upper limit value may be determined as the product of the changed virtual gear ratio value by +100 in the torque range of the virtual gear ratio corresponding to the changed virtual gear ratio, and the lower limit value of the torque range may be determined as the product of the changed virtual gear ratio value by −100.

As described above, since an upper limit value and a lower limit value are determined by a virtual gear ratio value changed by a driver, the torque range of the virtual gear stage corresponding to the changed virtual gear ratio can be newly determined.

Further, a driver may change the entire final gear ratio into a desired value in a setting menu through the interface 11.

Further, in some implementations, an upper critical speed for determining a virtual red zone may be set in advance in the request torque determiner 21 or the virtual shift control unit 22 of the first control unit 20. Accordingly, when a virtual engine speed reaches the upper critical speed in a manual shifting mode, the request torque determiner 21 or the virtual shift control unit 22 of the first control unit 20 can determine that the virtual red zone (upper limit region) was reached.

The red zone copies a red zone in which fuel-cut control is performed on the engine of a vehicle with an internal combustion engine. When a virtual engine speed reaches the virtual red zone in the manual shifting mode, as described above, the first control unit 20 can perform virtual fuel-cut control that copies a fuel-cut situation of an engine.

While performing the virtual fuel-cut control, the first control unit 20 can generate a motor torque instruction (final torque instruction) that prevents start torque of a vehicle from being generated or a vehicle from being accelerated until a driver manually shifts.

In this case, the first control unit 20 can generate and output a motor torque instruction determining the upper critical speed, at which the virtual red zone is started, as a control target, and the second control unit 30 controls a motor that is the driving device 41 in accordance with the motor torque instruction output from the first control unit 20.

Accordingly, a virtual fuel-cut situation in which a vehicle is not started or accelerated regardless of driving input information by a driver when a driver does not manually shift in the manual shifting mode can be implemented.

As an example of control, proportional torque reduction control or PID torque control that uses the difference between a current virtual engine speed and the upper critical speed may be performed. As another method, when a virtual engine speed exceeds the upper critical speed, a motor torque instruction is set as a predetermined value to decelerate a vehicle, and when virtual engine speed decreases under the upper critical speed, a motor is normally controlled in accordance with driving input information by a driver. Accordingly, it is possible to limit a virtual engine speed not to exceed the upper critical speed.

As described above, generating a motor torque instruction that prevents start torque from being generated or a vehicle from the accelerated when a virtual engine speed reaches the upper critical speed is for preventing the virtual engine speed from entering the virtual red zone (upper limit region).

When determining that the virtual red zone has been entered in the manual shifting mode, the first control unit may additionally add a correction torque value for generating an intentional torque ripple to the motor torque instruction.

In this case, correction torque having a torque ripple having preset magnitude and cycle may be added to the motor torque instruction by the first control unit 20, and a motor that is the driving device 41 can be controlled in accordance with the motor torque instruction (final torque instruction) to which the correction torque value is added by cooperation of the first control unit 20 and the second control unit 30. Accordingly, vehicle vibration can be generated by motor torque variation.

Therefore, when a virtual engine speed reaches the virtual red zone (upper limit region) in the manual shifting mode, vibration or jolt of a vehicle can be implemented, thereby informing a driver that the virtual engine speed has reached the red zone (upper limit region).

Similarly, a lower critical speed for determining a virtual engine stall speed may be set in advance in the first control unit 20 (the request torque determiner or the virtual shift control unit). Accordingly, the first control unit 20 can determine that the virtual engine stall region (lower limit region) has been reached when the virtual engine speed reaches the lower critical speed in the manual shifting mode.

The virtual engine stall region copies a region in which engine stall may be generated in a vehicle with an internal combustion engine, and the lower critical speed may be set as a common idle speed. Accordingly, when the virtual engine speed reaches the lower critical speed in the manual shifting mode, the first control unit 20 can prevent coating regenerative braking torque from being generated no longer.

In this case, the first control unit 20 may perform control for preventing the virtual engine speed from decreasing under a preset minimum speed (the lower critical speed set as an idle speed) even if a vehicle speed decreases.

When the virtual engine speed reaches the lower critical speed in the manual shifting mode, the first control unit 20 can add a correction torque value having a torque ripple with predetermined magnitude and cycle to the motor torque instruction and can control a motor that is the driving device 41 in accordance with the motor torque instruction (final torque instruction) to which the correction torque value is added.

Accordingly, it is possible to implement vibration or jolt of a vehicle when the virtual engine speed reaches the lower critical speed (lower limit region) without manual shifting by a driver in the manual shifting mode, thereby informing a driver that the virtual engine speed has reached the lower limit region.

Further, when shifting input is generated by intention of a driver, that is, when a shift manually shifts, the first control unit 20 ignores the shifting request generated by intention of the driver and stops a virtual shifting process for shifting into a virtual gear stage when it is expected that the virtual engine speed is in the upper limit region (virtual red zone) or the lower limit region after shifting.

In the present disclosure, the upper critical speed and the lower critical speed may be set as constant values that are not discriminated in accordance with the virtual gear stages in the first control unit 20, but may be set as different values in accordance with the virtual gear stages in the first control unit 20.

Hereafter, the process of virtual shifting is described with reference to a more detailed example.

In an automatic shifting mode, not a manual shifting mode, a virtual gear stage is determined from an accelerator pedal input value by a driver and a virtual vehicle speed (or a virtual engine speed), and when a virtual gear stage is changed, virtual shifting control is performed. However, in the manual mode, virtual shifting mode is performed only when a driver manually inputs his/her shifting intention by operating a paddle shift or a shift level.

For example, when the current virtual gear stage was the second gear stage and the virtual engine speed was 6000 rpm in the automatic shifting mode, but a driver accelerates a vehicle by continuously operating an accelerator pedal and the virtual engine speed becomes 6500 rpm, the virtual gear stage is changed into the third gear sage and virtual upshift is performed.

However, in the manual shifting mode, even though the engine speed becomes 6500 rpm in the same situation upshift into the third gear stage is not performed, and instead, torque that prevents acceleration to fix the gear stage at the second gear stage, thereby preventing the virtual engine speed from increasing over 6500 rpm.

However, even if it is not a shifting condition in the automatic shifting mode, when a driver inputs shifting intention by operating a paddle shift in the manual mode, virtual shifting is forcibly performed. Of course, if shifting has been prevented, shifting is not performed even if a driver wants forcible shifting through manual shifting.

As another example, when a driver inputs downshift intention from the third gear stage to the second gear stage by operating a paddle shift in the manual shifting mode, the upper limit region is meaningful in such downshift. The reason is because the virtual engine speed increases in downshift.

For example, if the current virtual gear stage is the third gear stage and the virtual engine speed is 5000 rpm, when a driver operates a paddle shift for downshift in the manual shifting mode, virtual shifting should be performed into the second gear stage.

However, if the inter-stage ratio between the second gear stage and the third gear stage is 1.5, ‘5000×1.5=7500 rpm’ is expected as the virtual engine speed at the point in time at which shifting into the second gear stage was finished under the assumption that the current speed is maintained.

In this case, if the red zone, that is, the upper limit region is started from 6500 rpm that is the upper critical speed, when downshift is forcibly performed from the third gear stage into the second gear stage, the engine speed becomes 7500 rpm after shifting is finished, which exceeds 6500 rpm that is the upper critical speed. Accordingly, in this case, the downshift input by a driver is ignored, downshift is not performed, and the third gear stage is maintained.

Similarly, when a driver input a forcible upshift intention from the first gear stage to the second gear stage by operating a paddle shift, a lower limit region is meaningful as a limit region for this upshift, which is because the virtual engine speed decreases in upshift.

For example, if the current virtual gear stage is the first gear stage and the virtual engine speed is 750 rpm, when a driver operates a paddle shift for upshift in the manual shifting mode, virtual shifting should be performed into the second gear stage.

However, if the inter-stage ratio between the first gear stage and the second gear stage is 1.5, ‘750/1.5=500 rpm’ is expected as the virtual engine speed at the point in time at which shifting into the second gear stage was finished under the assumption that the current speed is maintained.

In this case, if the virtual stall region, that is, the lower limit region is started from 700 rpm that is the lower critical speed, when upshift is forcibly performed from the first gear stage into the second gear stage, the engine speed becomes 500 rpm after shifting is finished, which is lower than 700 rpm that is the lower critical speed. Accordingly, in this case, the upshift input by a driver is ignored, upshift is not performed, and the first gear stage is maintained.

What is claimed is:

1. A control method for generating a virtual shifting experience of an electric vehicle, the control method comprising:
collecting, by a control unit, vehicle-driving information while the electric vehicle is driven;
determining, by the control unit, virtual variable information including a virtual gear stage based on the collected vehicle-driving information;
determining, by the control unit, a torque range corresponding to a current virtual gear stage of the determined virtual variable information;
determining, by the control unit, driver request torque corresponding to a driving input value from a driver of the vehicle-driving information within the determined torque range;
determining, by the control unit, virtual shift intervention torque for generating a virtual shifting experience according to the determined virtual variable information based on a determination that the virtual gear stage has been changed;
generating, by the control unit, a final torque instruction based on the determined driver request torque and the determined virtual shift intervention torque; and
controlling, by the control unit, a motor implemented in the electric vehicle based on the generated final torque instruction.

2. The method of claim 1, wherein the virtual variable information further includes a virtual engine speed that is determined from a vehicle drive system speed of the vehicle-driving information.

3. The method of claim 2, wherein the virtual engine speed is determined based on the vehicle drive system speed and a virtual gear ratio value corresponding to the current virtual gear stage.

4. The method of claim 2, further comprising controlling, by the control unit, a display device to display the virtual gear stage and the virtual engine speed.

5. The method of claim 2, further comprising controlling, by the control unit, a sound system in the electric vehicle to output a virtual driving sound corresponding to the virtual engine speed.

6. The method of claim 1, wherein a torque range is set for each of a plurality of virtual gear stages, and one or more torque ranges associated with a first set of the plurality of virtual gear stages are set in wider ranges than one or more torque ranges associated with a second set of the plurality of virtual gear stages, the first set being lower virtual gear stages than the second set.

7. The method of claim 1, wherein a torque range is set for each of a plurality of virtual gear stages, a torque range width is determined based on a determined virtual gear ratio value of a corresponding virtual gear stage, the torque range width being a difference between an upper limit value and a lower limit value of the torque range for each of the plurality of virtual gear stages.

8. The method of claim 7, wherein the upper limit value and the lower limit value of the torque range for each of the plurality of virtual gear stages are determined as values that are proportioned to a determined virtual gear ratio value of a corresponding virtual gear stage.

9. The method of claim 7, wherein the virtual gear ratio value of each of the plurality of virtual gear stages is determined as a value that is received from an input device implemented in the electric vehicle.

10. The method of claim 1, wherein the torque range of each of a plurality of virtual gear stages is a positive torque region, and
wherein determining the driver request torque comprises, based on an accelerator pedal input value being input as the driving input value to the control unit, determining the driver request torque as a value corresponding to the accelerator pedal input value between a lower limit value and an upper limit value of the torque range.

11. The method of claim 1, wherein a torque range of each of a plurality of virtual gear stages includes a negative torque region and a positive torque region, and
wherein determining the driver request torque comprises, based on an accelerator pedal input value being input as the driving input value to the control unit, determining the driver request torque as a value corresponding to the accelerator pedal input value between a lower limit value and an upper limit value of the torque range.

12. The method of claim 1, wherein, based on a determination that the determined virtual gear stage has been changed, the control unit uses a virtual gear stage before changing as the current virtual gear stage in determining the torque range.

13. The method of claim 1, wherein, based on a determination that the virtual gear stage has been changed according to manual shifting input information from the driver of the vehicle-driving information in determining the virtual variable information, the control unit uses a virtual gear stage before changing as the current virtual gear stage in determining the torque range.

14. The method of claim 13, wherein the virtual variable information further includes a virtual engine speed that is determined from a vehicle drive-train speed of the vehicle-driving information and a virtual gear ratio value corresponding to the virtual gear stage, and
based on (i) a determination that a virtual gear stage has been changed according to manual shifting input information from the driver and (ii) a virtual engine speed determined using a virtual gear ratio value of a virtual gear stage after the change exceeding a preset upper critical speed or being less than a preset lower critical speed, the control unit is configured to maintain a current virtual gear stage by blocking a change of a virtual gear stage and stop performing a process according to the change of the virtual gear stage.

15. The method of claim 1, wherein the virtual variable information further includes a virtual engine speed that is determined from a vehicle drive-train speed of the vehicle-driving information, and
wherein the method further comprises:
determining, by the control unit, a motor torque instruction for limiting the virtual engine speed not to exceed an upper critical speed, which is set for determining a virtual red zone, based on the virtual engine speed reaching the upper critical speed with a manual shifting mode being selected and without manual shifting being received from the driver, and
controlling, by the control unit, the motor based on the determined motor torque instruction.

16. The method of claim 15, wherein controlling the motor comprises controlling the motor such that vibration is generated by motor torque variation based on a final torque instruction obtained by adding a correction torque value having a torque ripple to the determined motor torque instruction.

17. The method of claim 1, wherein the virtual variable information further includes a virtual engine speed that is determined from a vehicle drive-train speed of the vehicle-driving information, and
wherein the method further comprises:
determining, by the control unit, a motor torque instruction for limiting the virtual engine speed not to be lower than a lower critical speed, which is set for determining a virtual engine stall region, based on the virtual engine speed reaching the lower critical speed with a manual shifting mode being selected and without manual shifting being received from the driver; and
controlling, by the control unit, the motor based on the determined motor torque instruction.

18. The method of claim 17, wherein controlling the motor comprises controlling the motor such that vibration is generated by motor torque variation based on a final torque instruction obtained by adding a correction torque value having a torque ripple to the determined motor torque instruction.
